(19) United States
(12) Patent Application Publication
(10) Pub. No.: US 2013/0302696 A1
(43) Pub. Date: Nov. 14, 2013

(54) MICROPOROUS MEMBRANE, METHOD FOR PRODUCING SAME, AND BATTERY SEPARATOR USING SAME

(71) Applicants: Takeshi Ishihara, Nasushiobara-shi (JP); Koichi Kono, Nasushiobara-shi (JP)

(72) Inventors: Takeshi Ishihara, Nasushiobara-shi (JP); Koichi Kono, Nasushiobara-shi (JP)

(73) Assignee: TORAY Battery Separator Film Co., Ltd., Nasushiobara-shi (JP)

(21) Appl. No.: 13/979,688

(22) PCT Filed: Jan. 17, 2012
(86) PCT No.: PCT/JP2012/050817

§ 371 Date: Jul. 15, 2013

(30) Foreign Application Priority Data
Jan. 25, 2011 (JP) 2011-013293

(51) Int. Cl. H01M 2/16

(52) U.S. Cl. CPC H01M 2/1653
USPC 429/253; 521/134

(57) ABSTRACT

The present invention is a microporous membrane comprising polymethylpentene (a), polyethylene (b), and polypropylene (c), the microporous membrane having a meltdown temperature of 180° C. or higher, a TD heat shrinkage at 170° C. of 35% or less, and a thickness change ratio per thickness of 10% or less.

An object of the present invention is to provide a microporous membrane having a high meltdown temperature, a low shutdown temperature, and resistance to heat shrinkage at high temperatures, which cannot be obtained by the prior art.

### TECHNICAL FIELD

The present invention relates to a microporous membrane having a high meltdown temperature and resistance to heat shrinkage at high temperatures. The microporous membrane of the present invention has a thickness change ratio per thickness (thickness standard deviation) of 10% or less and is obtained by melt-extruding a mixture of membrane-forming solvent and polymer at a mixing energy in the range of 0.1 to 0.65 KWh/kg, the mixture containing the polymethylpentene (a), the polyethylene (b), and the polypropylene (c); stretching the extruded mixture; and removing the membrane-forming solvent. The microporous membrane can be used as a battery separator film and the like, and preferably used particularly for a lithium ion battery.

### BACKGROUND ART

Microporous membranes are known to be useful as a battery separator film (hereinafter referred to as BSF) for primary and secondary batteries. Examples of such batteries include lithium ion secondary batteries, lithium polymer secondary batteries, nickel-hydrogen batteries, nickel-cadmium batteries, nickel-zinc batteries, silver-zinc batteries, and the like. Improving BSF properties can reduce the risk of abnormal reaction in batteries, which is beneficial particularly in lithium ion batteries.

As electrical activity under overcharge and rapid-discharge conditions continues in a battery, the battery temperature increases, and one mode of abnormal reaction in batteries occurs. To reduce this risk, polymer microporous membranes have been developed as a BSF having a failsafe property called shutdown. When a microporous membrane is exposed to a temperature higher than its shutdown temperature, polymer mobility increases, and air permeability of the microporous membrane is reduced. This reduces electrolyte transfer in the battery and reduces heat generation in the battery. BSFs having a low shutdown temperature have been desired for improved battery safety.

Further, such a mode of abnormal reaction in batteries also causes BSF heat shrinkage due to elevated temperature, and this phenomenon occurs at between BSF's shutdown temperature and meltdown temperature. This is a typical phenomenon in prismatic and cylindrical batteries, and even a small change in microporous membrane width can result in cathode-anode contact at or near the battery's edges. To take advantage of increased safety margin provided by increasing the BSF's meltdown temperature, reduction of the amount of BSF heat shrinkage has been desired, and, in particular, reduction of the amount of heat shrinkage at or above the shutdown temperature has been desired.

Further, another abnormal reaction in batteries is reduction in mechanical strength of a microporous membrane at or above its meltdown temperature. Such a situation can occur when an internal short circuit converts electrical energy in a battery into heat to thereby generate heat or when a battery is exposed to external heat. The reduced strength resulting from the softened BSF increases the risk of cathode-anode contact and causes uncontrollable abnormal reaction in batteries. To reduce this risk, microporous membranes using polymethylpentene (hereinafter referred to as PMP) in order to increase their meltdown temperature have been disclosed in Patent Documents 1 to 4. It has been desired that the meltdown temperature be increased and the heat shrinkage rate be reduced without significantly degrading important BSF properties such as air permeability and strength.

To achieve a reduction in heat shrinkage rate at high temperatures and a high meltdown temperature, it has been desired to finely disperse polymer having a high melting point in polyethylene (Patent Documents 5 and 6). To achieve a reduction in heat shrinkage rate at high temperatures and a high meltdown temperature, it is important to finely disperse polymers having a different melting point. On the other hand, harsh mixing conditions degrade film properties due to reduced molecular weight resulting from molecular chain breakage. This is particularly pronounced in the case of polymer having a methane carbon base in its molecular chain: for example, polypropylene, polymethylpentene, and the like are readily degraded during mixing. Currently, microporous membranes having an even higher meltdown temperature, a low shutdown temperature, and resistance to heat shrinkage at high temperatures are desired.

### PRIOR ART DOCUMENTS

### Patent Documents

Patent Document 1: WO 2010/058789
Patent Document 2: JP 2005-255876 A
Patent Document 3: JP 2003-142064 A
Patent Document 4: JP 07-060084 A
Patent Document 5: JP 2004-224915 A
Patent Document 6: JP 2005-200578 A

### SUMMARY OF THE INVENTION

### Problems to be Solved by the Invention

An object of the present invention is to provide a microporous membrane having a high meltdown temperature, a low shutdown temperature, and resistance to heat shrinkage at high temperatures, which cannot be obtained by the prior art.

### Means for Solving the Problems

To solve the problems described above, the microporous membrane of the present invention has the following constitution: i.e., a microporous membrane containing polymethylpentene (a), polyethylene (b), and polypropylene (c), the microporous membrane having a meltdown temperature of 180° C. or higher, a TD heat shrinkage at 170° C. of 35% or less, and a thickness change ratio per thickness of 10% or less.

To solve the problems described above, the process for producing the microporous membrane of the present invention has the following constitution: i.e., a process for producing a microporous membrane, including (i) melt-extruding a mixture of membrane-forming solvent and polymers at a mixing energy in the range of 0.1 to 0.65 KWh/kg, wherein the polymers contain the polymethylpentene (a), the polyethylene (b), and the polypropylene (c); (ii) cooling an extruded mixture of membrane-forming solvent and polymers to produce a gel-like sheet; (iii) stretching the extruded mixture in at least one direction; and (iv) removing the solvent from a stretched extrudate.

To solve the problems described above, the battery separator of the present invention has the following constitution: i.e., a battery separator using the microporous membrane described above.

To solve the problems described above, the battery of the present invention has the following constitution: i.e., a battery obtained by using the microporous membrane described above.

To solve the problems described above, the electric vehicle or hybrid vehicle of the present invention has the following constitution: i.e., an electric vehicle or hybrid vehicle connected to the battery described above.

The microporous membrane of the present invention preferably includes a polyolefin, wherein the polypropylene (c) is an isotactic polypropylene and has a weight average molecular weight Mw≧7.0×10⁵, a MWD≦10, and a ΔHm ≧90.0 J/g; and the polyethylene (b) has a weight average molecular weight Mw<1.0×10⁶, a MWD≦15.0, an amount of terminal unsaturated group ≦0.20/1.0×10⁴ carbon atoms, and a melting point Tm≧131.0° C. “MWD” as used herein refers to a value obtained by dividing Mw by number average molecular weight (the same shall apply hereinafter).

In the microporous membrane of the present invention, the polymethylpentene (a) is preferably obtained by using a polymethylpentene having a MFR of 80 dg/min or less and a melting point of 220 to 240° C.

In the microporous membrane of the present invention, the polyethylene is preferably obtained by using a first polyethylene and a second polyethylene, the first polyethylene having a weight average molecular weight Mw<1.0×10⁶, a MWD≦15, an amount of terminal unsaturated group ≦0.20/1.0×10⁴ carbon atoms, and a melting point Tm≧131.0° C., and the second polyethylene having a weight average molecular weight Mw≧1.0×10⁶, a MWD≦50, and a melting point Tm≧134.0° C.

The microporous membrane of the present invention preferably has a TD heat shrinkage rate at 105° C.≦5%, a TD shrinkage rate at 130° C.≦20%, a normalized pin puncture strength ≧70 mN/μm, an average thickness ≦30 μm, a porosity of 20 to 80%, and a normalized air permeability ≦100 seconds/100 cm³/μm.

In the process for producing the microporous membrane of the present invention, it is preferable to stretch the microporous membrane in at least one direction following the step (iii) and carry out a heat treatment.

In the process for producing the microporous membrane of the present invention, it is preferable to remove volatile components following the step (iii).

### Effects of the Invention

The microporous membrane of the present invention has a high meltdown temperature, a low shutdown temperature, and resistance to heat shrinkage at high temperatures, which cannot be obtained by the prior art. Further, the process for producing the microporous membrane of the present invention provides a microporous membrane having such properties, and the battery of the present invention having a high safety.

### BEST MODE FOR CARRYING OUT THE INVENTION

The microporous membrane of the present invention is obtained by adjusting the kind and amount of polymethylpentene (which hereinafter may be referred to as PMP), polypropylene (which hereinafter may be referred to as PP), and polyethylene (which hereinafter may be referred to as PE) and mix-extruding a mixture thereof and membrane-forming solvent at a mixing energy in the range of 0.1 to 0.65 KWh/kg, the microporous membrane having excellent properties such as a relatively high air permeability, a high strength, a low heat shrinkage rate at high temperatures, and, in addition, a small thickness change. The microporous membrane of the present invention is formed by microfibrils having a substantially uniform polymer phase. It is believed that the microporous membrane of the present invention provides such demand characteristics because of the presence of such microfibrils.

In the present invention, “polyethylene” is a polyolefin in which 50% or more (by number) of repeating ethylene-derived units are contained, preferably, a polyethylene homopolymer and/or a polyethylene copolymer in which polyethylene accounts for at least 85% (by number). “Polymethylpentene” is a polyolefin in which repeating methylpentene-derived units account for 50% or more (by number), preferably, a polymethylpentene homopolymer and/or a polymethylpentene copolymer in which at least 85% (by number) of the repeating units are methylpentene units.

In the present invention, “polypropylene” is a polyolefin in which 50% or more (by number) of repeating propylene-derived units are contained, preferably, a polypropylene homopolymer and/or a polypropylene copolymer in which polypropylene accounts for at least 85% (by number).

“Microporous membrane” refers to a thin film having pores, wherein 90% or more (by volume) of the pores in the film is a pore with an average diameter of 0.01 μm to 10.0 μm. With respect to microporous membranes produced by extrusion, “MD” refers to the direction in which an extrudate is extruded through a die, and “TD” refers to the direction perpendicular to MD and the thickness direction of the extrudate. MD and TD are also referred to as the planar direction, wherein the “planar direction” is a direction lying substantially planarly when the microporous membrane is flat.

### Composition of Microporous Membrane

The present invention relates to a microporous membrane containing polymethylpentene (a), polyethylene (b), and polypropylene (c). The polymethylpentene preferably has a MFR of 80 dg/min or less and a melting point of 200° C. or higher (the content of the polymethylpentene is more preferably 10 wt % or more based on the microporous membrane). Further, the polyethylene preferably includes a first polyethylene and a second polyethylene, wherein the first polyethylene has a weight average molecular weight Mw<1.0×10⁶, a MWD≦15.0, an amount of terminal unsaturated group ≦0.20/1.0×10⁴ carbon atoms, and a melting point Tm≧131.0° C. (the first polyethylene is more preferably 30 wt % or more based on the microporous membrane), and the second polyethylene has a weight average molecular weight Mw≧1.0×10⁶, a MWD≦50, and a melting point Tm≧134.0° C. (the second polyethylene is more preferably 5 wt % or more of the microporous membrane).

A preferred polypropylene is a polypropylene containing terminal unsaturated groups in an amount of more than 0.20/1.0×10⁴ carbon atoms.

The microporous membrane of the present invention has a meltdown temperature of 180° C. or higher, and preferably has a shutdown temperature of 131.0° C. or lower.

Further, the microporous membrane of the present invention has a TD heat shrinkage at 170° C. of 35% or less.

In the microporous membrane of the present invention, the content of PMP is preferably in the range of 5.0 wt % to 25.0 wt %; the content of PP is preferably in the range of 0.1 wt % to 25.0 wt %; and the content of PE (the total content in cases where a plurality of PEs are used (the same shall apply hereinafter)) is preferably 50.0 wt % to 95.0 wt %. The wt % is based on the weight of the microporous membrane. More preferably, in the microporous membrane, the content of PMP is 10.0 wt % to 25.0 wt %; the content of PP is 5.0 wt % to 15.0 wt %; and the content of PE is 60.0 to 85.0 wt %. The PE may be a mixture (preferably, dry mixed or a reactor blend) of the first PE and the second PE. More preferably, the PE mixture further includes a third PE, and the third PE still more preferably has a Mw>1.0×10⁶.

In this case, the first and second PEs are mixed to produce a PE mixture, the mixture containing the first PE in the range of 20.0 to 85.0 wt %, and the second PE in an amount of 0.0 to 40.0 wt %, preferably the second PE in an amount of 5.0 to 35.0 wt %, more preferably in an amount of 10.0 to 30.0 wt %. The wt % is based on the weight of the microporous membrane.

The microporous membrane can have at least one of the following properties: (1) the content of PMP in the microporous membrane is equal to or more than that of PP (the weight being based on the microporous membrane); (2) the PMP and the PP are contained in the microporous membrane in an amount of 25.0 wt % or more in total; (3) the PMP has a melting point Tm of 210 to 240° C., preferably 220 to 240° C., and more preferably 223.0 to 230.0° C., and the PMP has a MFR of 80 dg/min or less, preferably 10 to 40 dg/min, and more preferably 22.0 to 28.0 dg/min; and (4) the PP is an isotactic polypropylene, wherein the PP preferably has a Mw of 7.0×10⁵ or more, more preferably 0.8×10⁶ to 3.0×10⁶, and still more preferably 0.9×10⁶ to 2.0×10⁶, and the PP has a MWD of 10.0 or less, preferably 9.0 or less, more preferably 8.5 or less, still more preferably 2.0 to 10.0, and particularly preferably in the range of 2.5 to 8.5. Further, preferably, the PP has a heat quantity ΔHm of 90.0 J/g or more and more preferably 110 to 120 J/g.

The microporous membrane preferably has a heat shrinkage rate at 105° C. of 5.0% or less, a TD heat shrinkage rate at 130° C. of 20% or less, a normalized pin puncture strength of 70.0 mN/μm or more (more preferably 80 mN/μm or more), an average thickness of 30.0 μm or less, a porosity of 20% to 80%, and a normalized air permeability of not more than 100 seconds/100 cm³/μm.

For example, the microporous membrane of the present invention contains the first PE in an amount of 27.0 to 51.0 wt %, the first PE more preferably having a Mw in the range of 4.0×10⁵ to 6.0×10⁵, a MWD of 3.0 to 10.0, an amount of terminal unsaturated group of not more than 0.14/1.0×10⁴ carbon atoms, and a Tm of 132° C. or higher. Further, the second PE is more preferably contained in an amount of 0.0 to 40.0 wt %, the second PE having a weight average molecular weight Mw≧1.0×10⁶, a MWD≦50, and a melting point Tm≧134.0° C., and in the microporous membrane of the present invention, the PMP is more preferably contained in an amount of 19.0 to 23.0 wt %. Further, the microporous membrane of the present invention includes isotactic polypropylene particularly preferably in an amount of 10.0 to 20.0 wt %, the isotactic propylene having a Mw of 1.0×10⁶ or more (the wt % being based on the weight of the microporous membrane).

Such a microporous membrane has at least one of the following properties.

The microporous membrane of the present invention preferably has an average thickness of 15.0 to 30.0 μm, preferably has a meltdown temperature of 190° C. to 210° C., more preferably 197° C. to 205° C., preferably has a TD heat shrinkage rate at 105° C. of 5.0% or less, more preferably 0.01 to 5.0%, preferably has a TD heat shrinkage at 130° C. of 20% or less, more preferably 1.0 to 18.0%, preferably has a normalized air permeability of not more than 100 seconds/100 cm³/μm, more preferably has a porosity of 30.0 to 60.0%, and more preferably has a normalized pin puncture strength of 80.0 mN/μm or more, more preferably 80.0 mN/μm to 2.5×10² mN/μm.

The microporous membrane of the present invention includes micropores and microfibrils, the microfibrils including the PMP, the PP, the first polyethylene, and the second polyethylene. Preferably, substantially all the polymers in the microporous membrane are present in the microfibrils, and the percentage of all the polymers present in the microfibrils of the microporous membrane is preferably 90.0 wt % or more, more preferably 95.0 wt % or more, and still more preferably 99.0 wt % or more. On the other hand, preferably 10 wt % or less, more preferably 5 wt % or less, and more preferably 1 wt % or less of the PMP, the PP, and the first and/or second PE are present in structures that are not microfibril structure in the microporous membrane. The structures that are not microfibril are, for example, rafts, islands, spheres, and the like, and the wt % is based on the total of the PMP, the PP, and the first and second PEs. In addition, it is preferred that 90 wt % or more, preferably 95 wt % or more, and more preferably 99 wt % of the polymers in the microfibrils be single-phase, based on the weight of the microfibrils. Further, 10 wt % or less, 5 wt % or less, and 1 wt % or less of the microporous membrane is a phase-separated polymer (such as continuous, co-continuous, or discontinuous polyethylene and/or PMP phases), based on the weight of the microporous membrane.

The embodiments of the present invention suit a particular purpose of the invention, but the present invention is not limited thereto. Further, the description of the embodiments of the invention is not meant to prevent the present invention from being broadly construed. The microporous membrane of the present invention includes polymers, and such polymers will now be described in detail.

### Polymethylpentene (PMP)

The PMP is a polymer in which at least 80.0% of the repeating units derive from methylpentene. The PMP preferably has a melting point Tm of 220 to 240° C., and more preferably 220 to 230° C. When the difference in melting point between the PMP and the PE is large, it is difficult to produce a uniform mixture of the PMP and the PE; thus the PMP still more preferably has a melting point Tm of 230° C. or lower. When the PMP has a melting point of 200° C. or higher, it is easy to achieve a relatively high meltdown temperature. The Tm of the PMP is measured with a differential scanning calorimeter (DSC) in the same manner as described below for PP.

The PMP preferably has a MFR of 80 dg/min or less (MFR is measured according to ASTM D 1238; 260° C./5.0 kg), more preferably 0.5 to 60.0 dg/min, and still more preferably 1 to 40 dg/min. When the PMP has a MFR of 80 dg/min or less, it is easy to achieve a relatively high meltdown temperature. The PMP preferably has a Mw of 1.0×10⁴ to 1.0×10⁶. The Mw and MWD of the PMP can be determined by gel permeation chromatography using the method described in “Macromolecules, Vol. 38, pp. 7181-7183 (2005)” in the same manner as described below for PP.

The PMP can be produced using a Ziegler-Natta catalyst (catalyst containing titanium, or titanium and manganese) or a single-site catalyst. The PMP is produced by carrying out coordination polymerization using 1-methylpentene monomer such as 4-methyl-1-pentene or 1-methylpentene and at least one α-olefin. Preferably, as the α-olefin, at least one of 1-butane, 1-pentene, 3-methyl-1-butene, 1-hexene, 4-methyl-1-pentene, 1-heptene, 1-octane, 1-nonene, and 1-decane is used. Examples of cyclic comonomers that can be used include cyclopentene, 4-methylcyclopentene, norbornene, tricyclo-3-decane, and the like. Examples of comonomers include 1-hexene and 1-octane. The comonomer has carbon atoms in the range of C₁₀ to C₁₈, and preferably C₁₆ to C₁₈. In general, comonomer is contained in PMP in an amount of 20.0 mol % or less.

The PMP may be a PMP mixture (for example, dry mixed or a reactor blend). The melting point of the PMP mixture can be 250° C. or lower, and preferably 240.0° C. or lower.

### Polyethylene

The microporous membrane contains the first and second polyethylene, and optionally contains the third polyethylene.

### PE1

The first polyethylene (PE1) preferably used in the present invention preferably has a Mw of less than 1.0×10⁶, and more preferably 1.0×10⁵ to 0.90×10⁶. The PE1 preferably has a MWD in the range of 3 to 10, and the PE1 preferably has an amount of terminal unsaturated group of less than 0.20/1.0×10⁴ carbon atoms. More preferably, the PE1 has a Mw of 4.0×10⁵ to 6.0×10⁵, and the PE1 has a MWD of 3.0 to 10.0. The PE1 more preferably has an amount of terminal unsaturated group of not more than 0.14/1.0×10⁴ carbon atoms, particularly preferably not more than 0.12/1.0×10⁴ carbon atoms, and most preferably 0.05 to not more than 0.14/1.0×10⁴ carbon atoms (the lower limit is the limit of measurement). As the PE1, “SUNFINE” (registered trademark) SH-800 or SH-810 (Asahi Kasei Chemicals Corporation) can be used. PE2, PE3

The PE2 preferably used in the present invention has a Mw in the range of 1.0×10⁶ to 3.0×10⁶, more preferably 2.0×10⁶ or less, and a MWD of 20 or less, more preferably 2.0 to 20, and still more preferably in the range of 4.0 to 15.0. The PE2 is an ethylene homopolymer or an ethylene/α-olefin copolymer, wherein at least one or more comonomers such as α-olefin is 5.0 mol % or less (the mol % being a value based on 100% of the copolymer). The comonomer is selected from, for example, at least one of propylene, 1-butene, 1-pentene, 1-hexene, 4-methyl-1-pentene, 1-octene, vinyl acetate, methyl methacrylate, and styrene. Such a polymer or copolymer can be produced using a Ziegler-Natta catalyst or a single-site catalyst, but it is not necessary to use it. Such a PE preferably has a melting point of 134° C. or higher. Further, the PE2 is preferably ultra high molecular weight polyethylene (UHMWPE), specifically, for example, HI-ZEX MILLION 240-m polyethylene.

The PE3 optionally used in the present invention has a Tm of 115.0 to 130.0° C., a Mw of 5.0×10³ to 4.0×10⁵, more preferably 1.0×10⁶ to 5.0×10⁶, and a MWD of 50 or less, more preferably 1.2 to 20.0.

A polyethylene copolymer is contained, and the polyethylene copolymer optionally has a MWD of 20.0 or less, e.g., about 2.0 to about 10.0, and, e.g., about 2.5 to about 4.5. The polyethylene is a copolymer of ethylene and a comonomer such as α-olefin. The α-olefin may be, for example, propylene, butene-1, pentene-1, hexene-1,4-methylpentene-1, octene-1, vinyl acetate, methyl methacrylate, styrene, other comonomers, or combinations thereof. In one embodiment, the α-olefin is propylene, butene-1, pentene-1, hexene-1,4-methylpentene-1, octene-1, and a combination thereof. In another embodiment, the comonomer is hexene-1 and/or octene-1. The amount of comonomer in the comonomer is 5.0 mol % or less, e.g., in the range of 1.0 mol % to 5.0 mol %, and, e.g., 1.25 mol % to 4.50 mol %.

The polymer can be produced by any convenient process, such as a process using a Ziegler-Natta or single-site polymerization catalyst. Optionally, the first polyethylene is one or more of a low density polyethylene (“LDPE”), a medium density polyethylene, a branched low density polyethylene, or a linear low density polyethylene, such as a polyethylene produced using a metallocene catalyst. For example, the polymer can be produced according to the method disclosed in U.S. Pat. No. 5,084,534, which is incorporated by reference herein in its entirety

The melting point of the PE1, PE2, and PE3 can be measured, for example, by the method described in PCT Publication No. WO 2008/140835.

The microporous membrane includes polypropylene.

The polypropylene may be a homopolymer or a copolymer with other olefins, but a homopolymer is preferred. The copolymer may be a random or block copolymer. Examples of olefins other than propylene include α-olefins such as ethylene, butene-1, pentene-1, hexene-1,4-methylpentene-1, octene-1, vinyl acetate, methyl methacrylate, and styrene; and diolefins such as butadiene, 1,5-hexadiene, 1,7-octadiene, and 1,9-decadiene. The percentage of the other olefins in the propylene copolymer is not particularly limited as long as physical properties such as heat resistance, compression resistance, and heat shrinkage resistance are not impaired, and, specifically, it is preferable to be less than 10 mol %.

The PP preferably has a Mw of 6.0×10⁵ or more, more preferably 7.5×10⁵ or more, still more preferably 0.80×10⁶ to 4.0×10⁶, and particularly preferably 0.90×10⁶ to 3.0×10⁶. Preferably, the PP has a melting point of 160.0° C. or higher and a heat quantity ΔHm of 90.0 J/g or more, more preferably 100.0 J/g or more, and still more preferably 110 to 120 J/g. Further, the PP preferably has a MWD of 10 or less, more preferably 8.5 or less, still more preferably 1.5 to 10.0, particularly preferably 2.0 to 9.0, and most preferably in the range of 2.5 to 8.5. The PP is preferably a copolymer (random, block) of polypropylene, wherein 5.0 mol % or less of the copolymer contains those selected from at least one α-olefin such as ethylene, 1-butene, 1-pentene, 1-hexene, 4-methyl 1-pentene, 1-octene, vinyl acetate, methyl methacrylate, or styrene, and diolefins such as butadiene, 1,5-hexadiene, 1,7-octadiene, and 1,9-decadiene.

The PP is preferably an isotactic polypropylene. The isotactic polypropylene has a meso pentad fraction of 50.0 mol % mmmm pentads, preferably 94.0 mol % mmmmm pentads, and more preferably 96.0 mol % mmmm pentads (based on the total mol of the isotactic PP). The PP has (a) a meso pentad fraction of 90.0 mol % mmmm pentads or more, preferably 94.0 mol % mmmm pentads, and (b) an amount of stereo defects of 50.0/1.0×10⁴ carbon atoms, preferably not more than 20/1.0×10⁴ carbon atoms, not more than 10.0/1.0×10⁴ carbon atoms, and not more than 5.0/1.0×10⁴ carbon atoms. Preferably, the PP has at least one of the following properties: a Tm of 162° C. or higher; an elongational viscosity of 5.0×10⁴ Pa·s or more at a strain rate of 25/s and 230° C.; a Trouton ratio of 15 or more measured at a strain rate of 25/s and 230° C.; a MFR of 0.1 dg/min (ASTM D 1238-95 Condition L at 230° C. and 2.16 kg), preferably 0.01 dg/min (such a low value that cannot be measured as a MFR); and an amount of extractable species (extracted from the PP in boiling xylene) of 0.5 wt % or less, more preferably 0.2 wt % or less, and still more preferably 0.1 wt % or less, the wt % being based on the weight of the PP.

The polypropylene (PP1) preferably used in the present invention is an isotactic PP and preferably has a Mw of 0.8×10⁶ to 3.0×10⁶, preferably 0.9×10⁶ to 2.0×10⁶; a MWD of 8.5 or less, 2.0 to 8.5, and further 2.0 to 6.0; and a ΔHm of 90.0 J/g or less. In general, such a PP has a meso pentad fraction of 94.0 mol % mmmm pentads, stereo defects of 5.0/1.0×10⁴ carbon atoms, and a melting point of 162.0° C. or higher.

Although not limited thereto, the melting point, meso pentad fraction, tacticity, intrinsic viscosity, Trouton ratio, stereo defects, and extract quantity of the PP can be determined by the method described in PCT Publication No. WO 2008/140835.

The ΔHm of the PP can be measured by the method described in PCT Publication No. WO 2007/132942. The melting point can be obtained by DSC using a PerkinElmer Pyris 1 DSC. A sample adjusted to 5.5 to 6.5 g is sealed in an aluminum pan, and the temperature is raised from 30° C. to 230° C. at a rate of 10° C./min, which is called a first melt (no data recorded). The sample is kept at 230° C. for 10 minutes before a cooling cycle is applied. The sample is then cooled from 230° C. to 25° C. at a cooling rate of 10° C./min, which is called crystallization, and then kept at 25° C. for 10 minutes. Thereafter, the temperature is raised to 230° C. at a rate of 10° C./min (second melt). In measurements of the melting point of the PMP, 270° C. is employed in place of 230° C. The thermal analyses in both the crystallization and the second melt are recorded. The peak of the second melting curve is a melting point (Tm), and the crystallization peak temperature is a crystallization temperature (Tc).

### Other Additives

Inorganic matter (such as compounds containing silicon and/or aluminum atoms) and/or heat-resistant polymer disclosed in PCT Publication No. WO 2007/132942 or WO 2008/016174 can be present preferably in the first and/or second layer.

When the microporous membrane is produced by extrusion, the final microporous membrane is produced from a polymer commonly used for extrusion. A small amount of solvent or other compounds can be present during this process, the content of which is generally 1 wt % or less of the microporous membrane. Degradation of a small amount of polymer may occur at the production stage, and when it occurs, the value of MWD is larger than the MWD of the polymer used to produce a microporous membrane before the process by up to 10%, preferably up to 1%, and more preferably up to 0.1%.

### Determination of Mw and MWD

Mw and MWD are determined using a high temperature size exclusion chromatograph, i.e., “SEC” (GPC PL 220, Polymer Laboratories), equipped with a differential refractive index detector (DRI). Three PLgel Mixed-B columns (available from Polymer Laboratories) are used. Measurements are made in accordance with the procedure disclosed in “Macromolecules, Vol. 34, No. 19, pp. 6812-6820 (2001)”. For polyethylene, the standard flow rate is 0.5 cm³/min; the standard injection volume is 300 μL; and transfer lines, columns, and a DRI detector are placed in an oven maintained at 145° C. For polypropylene and polymethylpentene, the standard flow rate is 1.0 cm³/min; the standard injection volume is 300 μL; and transfer lines, columns, and a DRI detector are placed in an oven maintained at 160° C.

The reagent used for GPC is Aldrich grade 1,2,4-trichlorobenzene (TCB) containing 1,000 ppm of butylhydroxytoluene (BHT). The TCB is degassed with an online degasser prior to introduction into the SEC. A polymer solid solution is placed in a container as a dry polymer. A desired amount of TBC solvent is added, and the resulting mixture is continuously stirred at 160° C. for 2 hours. The concentration of the polymer solid solution is 0.25 to 0.75 mg/ml, and the sample polymer solid solution is filtered off-line prior to introduction into the GPC using SP260 Sample Prep Station (available from Polymer Laboratories) having a 2-μm filter.

The separation efficiency of the column set is calculated with a calculation curve generated using a standard range of the Mp of 17 individual polystyrenes. “Mp” is defined as the peak in Mw. Polystyrene standards are available from Polymer Laboratories (Amherst, Mass.). The calculation curve (logMp vs. retention volume) is represented as a retention volume of the peak in the DRI signal of each polystyrene standard, and represented as a 2nd-order fitted curve. Samples are analyzed using IGOR Pro available from Wave Metrics, Inc.

### Process for Producing Microporous Membrane

In one or more embodiments of the microporous membrane, PMP, PE1, PE2, preferably, and/or PE3, PP (by dry blending or melt blending), membrane-forming solvent, and additive components such as inorganic fillers are used as a mixture, and the mixture is extruded from an extruder. For example, PMP, PP, PE1, and PE2 are mixed with membrane-forming solvent such as liquid paraffin, and the mixture is extruded in the form of a monolayer membrane. Additional layers can be added, if desired, before extrusion to produce a microporous membrane provided with a low shutdown function. In other words, monolayer extrudates or monolayer microporous membranes can be laminated or co-extruded to form a multilayer membrane.

Such a process for producing a membrane may have additional steps: e.g., the step of removing volatile components from the membrane after removing the membrane-forming solvent, subjecting the membrane to a heat treatment (heat setting or annealing) before or after removing the membrane-forming solvent, stretching the extrudate in at least one direction before solvent removal, and/or stretching the membrane in at least one planar direction after solvent removal. A hot solvent treatment step, a heat setting step, a cross-linking step with ion irradiation, a hydrophilization step, and the like that are suitably used are described in PCT Publication No. WO 2008/016174.

### Production of Mixture of Polymers and Membrane-Forming Solvent

In one or more embodiments of the microporous membrane, PMP, PE1, PE2, and PP, preferably, and/or PE3 (by dry blending or melt blending), membrane-forming solvent, and additive components such as inorganic fillers are used as a mixture, and the mixture is extruded from an extruder to produce an extruded mixture. Mixing can be conducted using, for example, a reaction extruder. Examples of the type of extruder used in the present invention include, but are not limited to, a twin-screw extruder, ring extruder, planar extruder, and the like, and the present invention is not restricted by the kind of reaction extruder. Examples of additives preferably used in the mixture of membrane-forming solvent and polymer include, for example, fillers, antioxidants, stabilizers, and/or heat resistant resins. The type and kind of additive that is preferably used can be the same as those described in PCT Publications No. WO 2007/132942, WO 2008/016174, and WO 2008/140835.

The membrane-forming solvent is generally compatible with the polymers and used for extrusion. For example, the membrane-forming solvent may be any type of solvent or a combination thereof and can be combined with a resin as a single phase at an extrusion temperature. Specific examples of membrane-forming solvents include aliphatic hydrocarbons or cyclic hydrocarbons such as nonane, decane, decalin, paraffin oil, and phthalic acid esters such as dibutyl phthalate and dioctyl phthalate. Paraffin oil having a kinetic viscosity at 40° C. of 20 to 200 cSt can be preferably used, and the paraffin oil described in U.S. Patent Application Publications No. 2008/0057388 and No. 2008/0057389 can be used.

The polymers and the membrane-forming solvent are mixed at a mixing energy of 0.1 to 0.65 KWh/kg. Preferably, the mixing energy is not less than 0.12 KWh/kg and less than 0.60 KWh/kg. When the mixing energy is in this range, the stretching magnification can be increased, and a high yield point and high strength can be provided. When the mixing energy is 0.12 KWh/kg or more, the PMP has good dispersibility in the mixture, and the planarity of a film improves. For example, in the case of a substantially homogenous polymer, e.g., a polymer that shows no phase separation, the membrane has better planarity and a thickness change ratio of 10% or less.

When the mixing energy is more than 0.65 KWh/kg, biaxial stretchability will be poor due to polymer degradation, making it difficult to conduct 3×3-fold or more stretching.

When the mixing energy in not less than 0.12 KWh/kg and not more than 0.65 KWh/kg, polymer degradation can be reduced, and an excellent value of properties such as air permeability can be maintained. A higher mixing energy is believed to cause a reduction in molecular weight of the polymer, leading to poor air permeability.

The polyolefins are mixed in an extruder at a rotation rate of preferably 450 rpm or less, more preferably 430 rpm or less, and still more preferably 410 rpm or less, and preferably 150 rpm or more, more preferably 250 rpm or more, and still more preferably 150 rpm or more. The temperature during the mixing of the mixture of polymer and membrane-forming solvent is preferably 140° C. to 250° C., and more preferably 210° C. to 240° C. The amount of the membrane-forming solvent used in the extrusion is preferably 20.0 wt % to 99.0 wt %, and more preferably 60.0 wt % to 80.0 wt %.

### Production of Extrudate

The mixture of polymers and membrane-forming solvent is extruded through a die to form an extrudate. The extrudate is adjusted to have a preferred thickness for the following step such that a desired average thickness (1.0 μm or more) of the final membrane after stretching can be achieved. For example, the thickness of the extrudate is 0.1 mm to 10 mm or 0.5 to 5 mm. The extrusion is conducted with the mixture in the molten state. When a die for producing a sheet is used, the die is generally heated to 140 to 250° C. Preferred production conditions are described in PCT Publications No. WO 2007/132942 and WO 2008/016174.

If desired, the extrudate is exposed to a temperature in the range of 15 to 80° C. to form a cooled extrudate. Cooling rate, though not particularly critical, is preferably less than 30° C./min, and the extrudate is cooled to around the gelation temperature of the extrudate. Production conditions for cooling are described in PCT Publications No. WO 2007/132942, WO 2008/016174, and WO 2008/140835.

### Stretching of Extrudate (Upstream Stretching)

The extrudate or cooled extrudate is stretched in at least one direction (upstream stretching or wet stretching), e.g., in MD or TD. Such a stretching results in orientation of the polymer in the mixture. The extrudate can be stretched using a tenter, and roll stretching, the inflation method, or a combination thereof can be used. These methods are described, for example, in PCT Publication No. WO 2008/016174. The stretching is conducted monoaxially or biaxially, though biaxial stretching is preferred. In the case of biaxial stretching, simultaneous biaxial stretching, stepwise biaxial stretching, multi-stage stretching, or a combination thereof can be used, though simultaneous biaxial stretching is preferred. When biaxial stretching is used, the stretching magnification need not be the same in each stretching direction.

The stretching magnification is, for example, 2-fold or more, and preferably 3- to 30-fold (in the case of monoaxial stretching). In the case of biaxial stretching, the stretching magnification is 3-fold or more, preferably 9-fold or more, more preferably 16-fold or more, and still more preferably 25-fold or more. In the stretching step, a 9-fold to 49-fold stretching magnification is particularly preferred.

The temperature during the stretching of the extrudate can be Tcd to Tm, wherein Tcd is a crystal dispersion temperature of polyethylene, and Tm is a melting point of the polyethylene having the lowest melting point among the polyethylenes used for the extrudate. The crystal dispersion temperature is determined as a temperature of the properties of the dynamic viscoelasticity measurement described in ASTM D 4065. In the present invention, Tcd is preferably 90° C. to 100° C., and the stretching temperature is preferably 90° C. to 125° C. The stretching temperature is more preferably 100° C. to 125° C., and still more preferably 105° C. to 125° C.

When a sample is heated, it is preferred that an atmosphere be formed with hot air and the hot air be conveyed to the proximity of the sample.

### Removal of Membrane-Forming Solvent

To obtain a dried membrane, the membrane-forming solvent is removed from a stretched extrudate. Solvent for removal is used to remove the membrane-forming solvent. The method for this is described, for example, in PCT Publication No. WO 2008/016174.

Residual volatile components are removed from the dried membrane after removing diluent components. Various methods can be used to remove washing solvent, e.g., heat-drying, air-drying, and the like. For conditions of the washing solvent for removing volatile components, the same method as in PCT Publication No. WO 2008/016174 can be used.

### Stretching of Membrane (Downstream Stretching)

Stretching of the dried membrane (called “downstream stretching” or “dry stretching”, stretching is conducted after at least the membrane-forming solvent has been removed) is conducted at least in one direction, e.g., MD and/or TD. Such stretching results in orientation of the polymer in the membrane. The orientation indicates that downstream stretching has been carried out. In downstream stretching before dry stretching, TD length in the width direction is called an initial dry width, and MD length in the length direction is called an initial dry length. Equipment in the tenter stretching method is described in PCT Publication No. WO 2008/016174, and the same method can be used.

The dried membrane can be stretched in MD from the initial dry length to the second dry length, and the stretching magnification is preferably in the range of 1.1 to 1.6, and more preferably 1.1 to 1.5. For the stretching in TD, the stretching magnification is preferably not more than the stretching magnification in MD, and preferably 1.1- to 1.6-fold. In the dry stretching (also called re-stretching because stretching has already been conducted in the state of an extrudate containing the membrane-forming solvent), stepwise stretching or simultaneous biaxial stretching can be used in MD and TD. Because TD heat shrinkage, compared to MD heat shrinkage, has a great effect on battery properties, the stretching magnification in TD generally does not exceed the stretching magnification in MD. In the case of biaxial stretching, the dried membrane is preferably stretched simultaneously in MD and TD. When the dry stretching is stepwise, the dried membrane is preferably stretched in MD and TD in the order mentioned.

In the dry stretching, the dried membrane is stretched at a temperature not higher than Tm, e.g., in the range of Tcd-30° C. to Tm. The membrane is exposed to a temperature in the range of 70° C. to 135° C., preferably 120° C. to 132° C., and more preferably 128° C. to 132° C.

The stretching magnification in MD is 1.0 to 1.5, and preferably 1.2 to 1.4. The stretching magnification in TD is 1.6 or less, 1.1 to 1.55, preferably 1.15 to 1.5, and more preferably 1.2 to 1.4. In the dry stretching, the temperature of the membrane is 80 to 132° C., and preferably 122° C. to 130° C.

The stretching rate is preferably 3%/sec or more in both MD and TD, each individually selected. The stretching rate is more preferably 5%/sec or more, and still more preferably 10%/sec or more. The stretching rate is preferably in the range of 5 to 25%/sec. The upper limit is preferably 50%/sec to prevent membrane rupture.

### Controlled Reduction in Membrane Width

Following the dry stretching, the dried membrane is subjected to a controlled reduction in width and adjusted from the second dry width to a third dry width. The third dry width is at least 1.1 times larger than the initial dry width. The width reduction step is generally conducted while exposing the membrane to a temperature of Tcd-30° C. to Tm. For example, the membrane is preferably exposed to a temperature in the range of 70° C. to 135° C. The temperature is more preferably 122 to 132° C., and still more preferably 125 to 130° C. The temperature can be the same temperature as the orientation temperature in the downstream stretching. The reduction in membrane width is conducted at a temperature lower than Tm of the membrane. The third dried membrane width is preferably 1.0 time to 1.4 times the initial dry width.

The temperature in the width reduction step is preferably equal to or higher than the temperature during the stretching in TD from the standpoint of heat shrinkage rate.

### Heat Set

The membrane is preferably subjected to heat treatment at least once after solvent removal. For example, dry stretching, controlled reduction in width, or both is preferably conducted. It is believed that heat setting stabilizes crystals and form uniform lamellas in the membrane. The heat setting is conducted by exposing the membrane to a temperature between Tcd and Tm, preferably 100° C. to 135° C., more preferably 120° C. to 132° C., and still more preferably 122° C. to 130° C. The heat setting temperature can be the same temperature as the downstream stretching temperature. In general, the heat setting is conducted for a time sufficient to form uniform lamellas in the membrane, e.g., 1,000 seconds or less, and preferably a time in the range of 1 second to 600 seconds. The heat setting is preferably conducted under conventional heat fixing conditions, and “heat fixing” refers to a heat setting conducted while maintaining the length and width (e.g., using tenter clips).

Annealing can be conducted after the heat setting. The annealing is a heat treatment conducted without applying a load to the membrane. The annealing can be conducted in a chamber having a belt conveyor or by using a hot-air type chamber. The annealing can also be conducted continuously after the heat setting with the tenter clips slackened. During the annealing, the membrane is exposed to a temperature not higher than Tm, preferably, a temperature from 60° C. to Tm-5° C. The annealing is believed to improve strength and air permeability.

Preferably, heated rollers, hot solvents, cross-linking agents, hydrophilizing agents, coating treatment, and the like can be used. These are described in PCT Publication No. WO 2008/016174.

### Structure and Properties of Membrane

The microporous membrane of the present invention is permeable to liquid (hydrophilic and hydrophobic) at normal pressure. Thus, the membrane can be used as a battery separator or filter. A thermoplastic film is particularly useful as a battery separator for a secondary battery and can be used for a nickel-hydrogen battery, lithium ion battery, nickel-zinc battery, silver-zinc battery, lithium polymer battery, and the like. The present invention relates to a battery separator for a lithium ion secondary battery. Such batteries are described in PCT Publication No. WO 2008/016174. Preferably, the membrane has at least one of the following properties.

### Thickness and Thickness Change Ratio

The final average thickness of the microporous membrane of the present invention is 1.0 μm or more, and preferably 1.0 to 1.0×10² μm. For example, in the case of monolayer membranes, the thickness is preferably in the range of 1.0 to 30.0 μm, and in the case of multilayer membranes, the thickness is 7.0 to 30.0 μm. For the average thickness, for example, a contact thickness meter can be used, and measurements are made at longitudinal intervals of 1 cm over the width of 10 cm to determine the average value. As a thickness meter, Rotary Caliper RC-1 manufactured by Mitsutoyo Corporation can be used. Noncontact thickness measurement can also be preferably used, and an optical thickness meter can be used.

The thickness change ratio per thickness can be determined by dividing the standard deviation of thickness by the average thickness. When the ratio is more than 10%, the adhesion to electrodes is reduced, causing degradation of battery performance. The ratio is preferably 10% or less, more preferably 8% or less, and still more preferably 6% or less. To achieve the thickness change ratio of 6%, the blending energy is preferably 0.1 kWh or more, more preferably 0.15 kWh or more, and still more preferably 0.2 kWh or more, in which case it is easy to reduce the thickness change ratio.

### Porosity of 20% or More

The porosity of the membrane is measured by a conventional method: comparison between the mass of the membrane (w1) and the weight of an equivalent non-porous polymer (w2) (for a polymer of the same width, length, and composition). The porosity is determined by the following equation.

Porosity (%)=(w2−w1)/w2×100

The porosity of the membrane is preferably in the range of 20.0% to 80.0%.

The porosity can be controlled by resin/solvent ratio, stretching magnification, stretching temperature, heat setting temperature, and the like.

Normalized Air Permeability of not More than 1.0×10² Seconds/100 Cm³/μm

The normalized air permeability (as measured according to JIS P 8117) is preferably not more than 1.0×10² seconds/100 cm³/μm, more preferably not more than 0.7×10² seconds/100 cm³/μm, still more preferably not more than 0.5×10² seconds/100 cm³/μm, and particularly preferably 4.0 seconds/100 cm³/μm to 1.0×10² seconds/100 cm³/μm. The normalized air permeability is 1.0-μm thickness equivalent. The normalized air permeability is described in JIS P 8117 and determined by the following equation.

A=1.0μm×(X)/T1

X is a measured value of air permeability, and A is a value converted in terms of a membrane with a thickness of 1.0 μm.

The air permeability can be controlled by resin/solvent ratio, stretching magnification, stretching temperature, heat setting temperature, and the like.

Normalized Pin Puncture Strength of not Less than 80.0 mN/1.0 μm

The normalized pin puncture strength of the membrane is a value converted in terms of a membrane with a thickness of 1.0 μm and a porosity of 50% [mN/μm]. The pin puncture strength is measured as the maximum load at normal temperature, and the measurements are made under conditions where a membrane having a thickness of T1 is pricked with a needle of 1 mm in diameter having a spherical tip (radius: 0.5 mm) at a rate of 2 mm/sec. The normalized pin puncture strength (S2) is represented by the following equation.

S₂=[50%×20μm×(S₁)]/[T₁×(100%−P)]

S₁ is a measured value of pin puncture strength; P is a measured value of membrane's porosity; and T₁ is the average thickness of a membrane. The normalized pin puncture strength of the membrane is preferably 70 mN/μm or more, more preferably 1.0×10² mN/μm or more, and still more preferably in the range of 1.0×10² mN/μm to 4.0×10² mN/μm.

The pin puncture strength can be controlled by resin/solvent ratio, stretching magnification, stretching temperature, heat setting temperature, and the like.

### Meltdown Temperature (as Measured as Membrane Rupture) of 180° C. Or Higher

The microporous membrane of the present invention has a meltdown temperature of 180° C. or higher, preferably 190° C. or higher, still more preferably 200° C. or higher, and particularly preferably 190 to 200° C. The meltdown temperature is measured as follows: a membrane of 5 cm×5 cm is sandwiched using metal block frames having a hole of 12 mm in diameter, and a tungsten carbide ball of 10 mm in diameter is placed on the microporous membrane; the microporous membrane is placed such that its surface is horizontal; the temperature is increased at 5° C./min starting from 30° C.; and the temperature at which the microporous membrane is ruptured by the ball is measured as a meltdown temperature.

The physical property described above can be achieved by using a given amount of PMP/PP. Specifically, the physical property described above can be satisfied when the sum of the PMP and PP is present in an amount of 25% or more.

### TD Heat Shrinkage Rate at 105° C. of 5% or Less

The microporous membrane of the present invention preferably has a TD heat shrinkage rate at 105° C. of 5% or less, more preferably 2.0%, and still more preferably 0.01 to 0.5%. The microporous membrane of the present invention preferably has a MD heat shrinkage at 105° C. of 5% or less, and more preferably 0.5 to 5%.

The heat shrinkage rate can be controlled by resin/solvent ratio, stretching magnification, stretching temperature, heat setting temperature, and the like. In particular, stretching magnification and heat setting temperature have a great effect.

The heat shrinkage at 105° C. of the membrane in the planar direction (MD, TD) is measured as follows: the dimension L₀ of the microporous membrane at 23° C. is measured (MD, TD), and the dimension L₁ after exposing a sample to conditions of 105° C. and 8 hours with no load applied is measured (MD, TD). The heat shrinkage rate in MD and TD is determined, as shown in the following equation, by dividing the dimensional change after 105° C. heat treatment by the dimension L₀ before heat treatment, and expressed as percentage.

[{L₀−L₁}/L₀]×100(%)

### TD Heat Shrinkage Rate at 130° C. and 170° C.

The microporous membrane of the present invention preferably has a TD heat shrinkage rate at 130° C. of 20% or less, more preferably 10% or less, and still more preferably 1% to 20%. The microporous membrane of the present invention has a TD heat shrinkage rate at 170° C. of 35% or less, preferably 28% or less, and still more preferably 15 to 30%.

The measurement of heat shrinkage rate at 130° C. and 170° C. is slightly different from the measurement of heat shrinkage rate at 105° C. A sample measuring 50 mm both in TD and MD is sandwiched at 23° C. between frames (such that the opening size is 35 mm in MD and 50 mm in TD). The frame with the sample attached is exposed to 130° C. or 170° C. for 30 minutes and then cooled. The TD heat shrinkage causes a slight inward bend along the direction parallel to MD (toward the center of the frame). The TD heat shrinkage rate is determined by dividing the difference between the TD length before heat treatment and the smallest TD length of the sample after heat treatment by the TD length of the sample before heat treatment, and expressed as percentage.

The heat shrinkage rate can be controlled mainly by controlling the amount of PMP/PP in the membrane and by controlling the stretching temperature, stretching magnification, and heat setting temperature.

The present invention will be described in detail with reference to Examples without limiting the scope of the present invention.

### EXAMPLES

### Example 1

### (1) Preparation of Mixture of Polymers and Membrane-Forming Solvent

A mixture of polymers and membrane-forming solvent is prepared by mixing liquid paraffin with a blend of PMP1, PP1, PE1, and PE2. The polymer blend is obtained by using (a) 20 wt % of polymethylpentene (PMP1) (Mitsui Chemicals, Inc. TPX MX002) (MFR: 21 dg/min, melting point Tm: 222° C.), (b) 20 wt % of polypropylene having a Mw of 1.1×10⁶, a MWD of 8.0, and a ΔHm of 114 J/g (PP1), (c) 30 wt % of polyethylene having a Mw of 5.6×10⁵, a MWD of 4.05, an amount of terminal unsaturated group of 0.14/1.0×10⁴ carbon atoms, and a melting point Tm of 136.0° C. (PE1), and (d) 30.0 wt % of polyethylene having a Mw of 1.9×10⁶ and a melting point of 136.0° C. (PE2). The wt % is based on the weight of the mixed polymer.

### (2) Production of Membrane

The mixture of polymers and membrane-forming solvent was fed to an extruder and extruded through a sheet-forming die as a sheet-like extrudate. The die temperature was 210° C. The extrudate is cooled using a cooling roll at 20° C. The cooled extrudate is simultaneously biaxially stretched using a tenter at 114° C. to a stretching magnification of 5 fold in both TD and MD. The stretched gel-like sheet is fixed to an aluminum frame of 20 cm×20 cm, and immersed in methylene chloride at 25° C., after which the liquid paraffin is removed by applying vibration at 100 rpm for 3 minutes, and then the resultant is dried under air flow at room temperature. During this process, the membrane was held at a constant size and then heat set at 125° C. for 10 minutes to form a final microporous membrane. Materials, process conditions, and membrane properties are shown in Table 1.

### Examples 2 to 5

### Comparative Example 1

A microporous membrane was produced in the same manner as in Example 1 except as shown in Table 1. Materials and process conditions are as shown in Table 1.

TABLE 1

| | | | | | | | Comparative |
|---|---|---|---|---|---|---|---|
| | | Example 1 | Example 2 | Example 3 | Example 4 | Example 5 | Example 1 |
| PMP | | PMP1 | PMP1 | PMP1 | PMP1 | PMP1 | PMP1 |
| | Content (wt. %) | 20.0 | 20.0 | 20.0 | 20.0 | 20.0 | 20.0 |
| PP | | PP1 | PP1 | PP1 | PP1 | PP1 | PP1 |
| | Content (wt. %) | 20.0 | 20.0 | 20.0 | 20.0 | 20.0 | 20.0 |
| PE | | PE1 | PE1 | PE1 | PE1 | PE1 | PE1 |
| | Content (wt. %) | 30.0 | 30.0 | 30.0 | 30.0 | 30.0 | 30.0 |
| | | PE2 | PE2 | PE2 | PE2 | PE2 | PE2 |
| | Content (wt. %) | 30.0 | 30.0 | 30.0 | 30.0 | 30.0 | 30.0 |

| | | | | | | |
|---|---|---|---|---|---|---|
| Production condition | | | | | | |
| Polymer concentration in the mixture (wt. %) | 28.5 | 28.5 | 28.5 | 28.5 | 28.5 | 25 |
| Extrusion | | | | | | |
| Extrusion temperature (° C.) | 220 | 220 | 220 | 220 | 220 | 220 |
| Rotation rate (rpm) | 150 | 200 | 225 | 150 | 200 | 450 |
| kt (kg-output/rpm) | 0.30 | 0.20 | 0.08 | 0.40 | 0.15 | 0.04 |
| Mixing energy (KWh/kg) | 0.156 | 0.208 | 0.5 | 0.144 | 0.267 | 0.667 |
| Stretching | | | | | | |
| Stretching temperature (° C.) | 114 | 114 | 114 | 114 | 114 | 114 |
| Stretching magnification (MD × TD) | 4 × 4 | 5 × 5 | 5 × 5 | 5 × 5 | 5 × 5 | 3 × 3 to |
| | | | | | | 5 × 5 |
| Heat set | | | | | | |
| Heat set temperature (° C.) | 125 | 125 | 125 | 125 | 125 | 125 |
| | | | | | | break of |
| | | | | | | membrane |
| Properties | | | | | | |
| Average thickness (μm) | 52 | 24 | 26 | 20 | 26 | — |
| Porosity (%) | 44 | 43 | 43 | 35.1 | 42.7 | — |
| Normalized air permeability | 93 | 58 | 91 | 58 | 81 | — |
| (sec/100 cm³/μm) | | | | | | |
| Pin puncture strength (mN/μm) | 71.6 | 112.8 | 111.8 | 165 | 111.8 | — |
| TD Heat shrinkage rate at 105° C. (%) | 3.0 | 3.3 | 3.3 | 3.4 | 3.0 | — |
| TD Heat shrinkage rate at 130° C. (%) | 8 | 13 | 13.6 | 15.6 | 14.1 | — |
| TD Heat shrinkage rate at 170° C. (%) | 22 | 30 | 29 | 35 | 30.3 | — |
| Meltdown temperature (° C.) | 201 | 203 | 198 | 197 | 198 | — |
| Shutdown temperature (° C.) | 131 | 134 | 134 | 134 | 134 | — |
| Standard deviation of thickness/ | 5.5 | 5.8 | 4.6 | 6.1 | 5.3 | — |
| Average thickness (%) | | | | | | |

### Examples 6, 7, and Comparative Examples 2, 3

A microporous membrane was produced in the same manner as in Example 1 except as shown in Table 2. In Comparative Examples, the following PMP was used as shown in Table 2.
(a) PMP2 (Mitsui Chemicals, Inc. TPX DX820, MFR=180 dg/min, Tm=236° C.), PMP3 (Mitsui Chemicals, Inc. TPX DX310, MFR=100 dg/min, Tm=223° C.)

TABLE 2

| | | | Compar- | | Compar- |
|---|---|---|---|---|---|
| | | Exam- | ative | Exam- | ative |
| | | ple 6 | Example 2 | ple 7 | Example 3 |
| PMP | | PMP1 | PMP1 | PMP1 | PMP2 |
| | Content (wt %) | 20.0 | 30.0 | 20.0 | 20.0 |
| PP | | PP1 | — | PP1 | PP1 |
| | Content (wt %) | 10.0 | 0.0 | 20.0 | 20.0 |
| PE | | PE1 | PE1 | PE1 | PE1 |
| | Content (wt %) | 40.0 | 40.0 | 30.0 | 30.0 |
| | | PE2 | PE2 | PE2 | PE2 |
| | Content (wt %) | 30.0 | 30.0 | 30.0 | 30.0 |

| | | | | |
|---|---|---|---|---|
| Production condition | | | | |
| Polymer concentration in the | 25 | 25 | 28.5 | 28.5 |
| mixture (wt. %) | | | | |
| Extrusion | | | | |
| Extrusion temperature (° C.) | 220 | 220 | 220 | 220 |
| Rotation rate (rpm) | 200 | 200 | 220 | 225 |
| kt (kg-output/rpm) | 0.15 | 0.15 | 0.08 | 0.08 |
| Mixing energy (KWh/kg) | 0.267 | 0.267 | — | — |
| Stretching | | | | |
| Stretching temperature (° C.) | 115 | 115 | 114 | 114 |
| Stretching magnification | 5 × 5 | 5 × 5 | 4 × 4 | 4 × 4 |
| (MD × TD) | | | | |
| Heat set | | | | |
| Heat set temperature (° C.) | 125 | 125 | 125 | 125 |
| Properties | | | | |
| Average thickness (μm) | 22 | 21 | 34 | 43 |
| Porosity (%) | 38 | 35.5 | 43.1 | 59.0 |
| Normalized air permeability | 34 | 102 | 45 | 6 |
| (sec/100 cm³/μm) | | | | |
| Pin puncture strength | 148 | 148 | 72 | 47 |
| (mN/μm) | | | | |
| TD Heat shrinkage rate at | 3.1 | 3.0 | 2.9 | 2.9 |
| 105° C. (%) | | | | |
| TD Heat shrinkage rate at | 13.8 | 13.1 | 11.6 | 13.3 |
| 130° C. (%) | | | | |
| TD Heat shrinkage rate at | 33.4 | 28.5 | 30.4 | 38.4 |
| 170° C. (%) | | | | |
| Meltdown temperature (° C.) | 190 | 203 | 211 | 177 |
| Shutdown temperature (° C.) | 134 | 132 | 134 | 152 |
| Standard deviation | 5.4 | 11.1 | 3.0 | 15.6 |
| of thickness/Average | | | | |
| thickness (%) | | | | |

### INDUSTRIAL APPLICABILITY

The microporous membrane of the present invention has a high meltdown temperature, a low shutdown temperature, and resistance to heat shrinkage at high temperatures. Therefore, the microporous membrane of the present invention can be used as a battery separator film and the like, and preferably used particularly for a lithium ion battery.

1. A microporous membrane comprising polymethylpentene (a), polyethylene (b), and polypropylene (c), the microporous membrane having a meltdown temperature of 180° C. or higher, a TD heat shrinkage at 170° C. of 35% or less, and a thickness change ratio per thickness of 10% or less.

2. The microporous membrane according to claim 1, wherein the polypropylene (c) is an isotactic polypropylene and has a weight average molecular weight Mw≧7.0×10⁵, a MWD≦10, and a ΔHm≧90.0 J/g; and the polyethylene (b) has a weight average molecular weight Mw<1.0×10⁶, a MWD≦15.0, an amount of terminal unsaturated group ≦0.20/1.0×10⁴ carbon atoms, and a melting point Tm≧131.0° C.

3. The microporous membrane according to claim 1, wherein the polymethylpentene (a) has a MFR of 80 dg/min or less and a melting point of 220 to 240° C.

4. The microporous membrane according to claim 1, wherein the polyethylene is obtained by using a first polyethylene and a second polyethylene, the first polyethylene having a weight average molecular weight Mw<1.0×10⁶, a MWD≦15, an amount of terminal unsaturated group ≦0.20/1.0×10⁴ carbon atoms, and a melting point Tm≧131.0° C., and the second polyethylene having a weight average molecular weight Mw≧1.0×10⁶, a MWD≦50, and a melting point Tm≧134.0° C.

5. The microporous membrane according to claim 1 having a TD heat shrinkage rate at 105° C.≦5%, a TD shrinkage rate at 130° C.≦20%, a normalized pin puncture strength ≧70 mN/μm, an average thickness ≦30 μm, a porosity of 20 to 80%, and a normalized air permeability ≦100 seconds/100 cm³/μm.

6. A battery separator using the microporous membrane according to claim 1.

7. A process for producing a microporous membrane, comprising (i) melt-extruding a mixture of membrane-forming solvent and polymers at a mixing energy in the range of 0.1 to 0.65 KWh/kg, wherein the polymers contain the polymethylpentene (a), the polyethylene (b), and the polypropylene (c); (ii) cooling an extruded mixture of membrane-forming solvent and polymers to produce a gel-like sheet; (iii) stretching the extruded mixture in at least one direction; and (iv) removing the solvent from a stretched extrudate.

8. The process for producing a microporous membrane according to claim 7, further comprising stretching the microporous membrane in at least one direction following the step (iii) and carrying out a heat treatment.

9. The process for producing a microporous membrane according to claim 7, comprising removing volatile components following the step (iii).

10. A battery obtained by using the microporous membrane according to claim 1.

11. An electric vehicle or hybrid vehicle connected to the battery according to claim 10.

12. The microporous membrane according to claim 2, wherein the polymethylpentene (a) has a MFR of 80 dg/min or less and a melting point of 220 to 240° C.

13. The microporous membrane according to claim 2, wherein the polyethylene is obtained by using a first polyethylene and a second polyethylene, the first polyethylene having a weight average molecular weight Mw<1.0×10⁶, a MWD≦15, an amount of terminal unsaturated group ≦0.20/1.0×10⁴ carbon atoms, and a melting point Tm≧131.0° C., and the second polyethylene having a weight average molecular weight Mw≧1.0×10⁶, a MWD≦50, and a melting point Tm≧134.0° C.

14. The microporous membrane according to claim 3, wherein the polyethylene is obtained by using a first polyethylene and a second polyethylene, the first polyethylene having a weight average molecular weight Mw<1.0×106, a MWD≦15, an amount of terminal unsaturated group ≦0.20/1.0×104 carbon atoms, and a melting point Tm≧131.0° C., and the second polyethylene having a weight average molecular weight Mw≧1.0×106, a MWD≦50, and a melting point Tm≧134.0° C.

15. The microporous membrane according to claim 2 having a TD heat shrinkage rate at 105° C.≦5%, a TD shrinkage rate at 130° C.≦20%, a normalized pin puncture strength ≧70 mN/μm, an average thickness ≦30 μM, a porosity of 20 to 80%, and a normalized air permeability ≦100 seconds/100 cm³/μm.

16. The microporous membrane according to claim 3 having a TD heat shrinkage rate at 105° C.≦5%, a TD shrinkage rate at 130° C.≦20%, a normalized pin puncture strength ≧70 mN/μm, an average thickness ≦30 μm, a porosity of 20 to 80%, and a normalized air permeability ≦100 seconds/100 cm3/μm.

17. The microporous membrane according to claim 4 having a TD heat shrinkage rate at 105° C.≦5%, a TD shrinkage rate at 130° C.≦20%, a normalized pin puncture strength ≧70 mN/μm, an average thickness ≦30 μm, a porosity of 20 to 80%, and a normalized air permeability ≦100 seconds/100 cm3/μm.

18. The process for producing a microporous membrane according to claim 8, comprising removing volatile components following the step (iii).
